(19) United States
(12) Patent Application Publication
(10) Pub. No.: US 2002/0101128 A1
(43) Pub. Date: Aug. 1, 2002

(54) Electric motor comprising a rotor mounted on one side

(75) Inventor: Niels Christian Weihrauch, Berlin (DE)

Correspondence Address: Michael B. Lasky, Altera Law Group, Suite 100, 6500 City West Parkway, Minneapolis, MN, 55343-7701, US

(73) Assignee: Danfoss Compressors GmbH

(21) Appl. No.: 10/103,154

(22) Filed: Mar. 20, 2002

Related U.S. Application Data
(63) Continuation of application No. PCT/DK00/00569, filed on Oct. 10, 2000.

(30) Foreign Application Priority Data
Oct. 12, 1999 (DE) 199 49 135.6

(51) Int. Cl. H02K 17/16

(52) U.S. Cl. 310/261

(57) ABSTRACT

The invention relates to an electric motor, comprising a rotor (1). One side of said rotor (1) is mounted in a stator (3) by means of a bearing (2) and the rotor tapers away conically from said stator in an axial direction, forming an air gap (4) between the latter (3) and the rotor. The width of said gap increases in an axial direction, moving away from the bearing (2). The aim of the invention is to achieve improved operating efficiency using a conically designed rotor. To this end, the rotor (1) has a number of axially extending grooves (7) in a magnetically conductive material (5), in which electric conductors are placed and the difference between the maximum value and the minimum value of the thickness of a cover (8) of the grooves (7) through the magnetically conductive material of the rotor (1) in a radial direction between the end of a groove (9) lying at the outer radius and a peripheral surface (10) of the rotor (1), is less than in the case of a thickness of the cover (8) which continuously diminishes in an axial direction away from the bearing (2).

The invention relates to an electric motor comprising a rotor that is mounted on one side in a stator by means of a bearing, tapers away conically from the bearing in an axial direction, and together with the stator forms an air gap, the width of which increases in the axial direction away from the bearing.

Such a motor is known from U.S. Pat. No. 5,233,254. In this motor, a damaging contact between rotor and stator, resulting from vibration that could arise due to the only one-sided mounting, is prevented in that the air gap between the rotor and the stator becomes steadily larger away from the bearing. Due to the enlarging of the air gap, the magnetization losses through scatter fields in the rotor are greater, so that the efficiency of the motor is diminished.

Known from DE 692 06 626 T2 is the design of a rotor that displays a number of axially extending grooves in a magnetically conductive material, in which grooves are arranged electrical conductors and which grooves have a varying profile in their longitudinal direction. These rotors display centrally a recess with enlarged diameter at one axial end. The axial grooves are arranged with their profiles changing stepwise in the longitudinal direction in such a manner that, despite the material loss through the enlarged diameter at the one end, in the core of the rotor no magnetic saturation occurs. Such an arrangement of the grooves is possible without problem in the case of a cylindrical rotor. However, in the case of a rotor with a conical design, in such an arrangement of the grooves the thickness of a covering of the grooves by the magnetically conductive material differs greatly towards a peripheral surface of the rotor at the two ends of the grooves, and in many cases only in small portions of the covering does a magnetic saturation occur, which saturation, however, is desired in order to increase the efficiency.

The object of the invention is the improvement of the efficiency of an electric motor in which the rotor has a conical design.

This object is achieved, in a motor of the type named in the introduction, in that the difference between the maximum and minimum values of the thickness of a covering of the grooves, by the magnetically conductive material of the rotor, in a radial direction between a radially-outer groove end and a peripheral surface of the rotor is less than in the case of a covering thickness that constantly diminishes in an axial direction away from the bearing.

This manner of design results in the fact that, through the small total covering of the grooves by the magnetically conductive material in the radial direction, the material in the covering region between the radially-outer groove end and the peripheral surface has a greater saturation, whereby the magnetic field is forced to jump over the air gap onto the stator. This improved coupling of the magnetic field to the stator generates an additional torque and increases the efficiency of the electric motor.

It is advantageous here that the grooves display, at their end facing the bearing, a different cross-sectional area than at their end opposite the bearing, and that between both ends of each individual groove a transition region is arranged. Through the different cross-sectional areas at the two ends of the individual grooves and the transition region situated between the two ends, the conical tapering of the rotor can be equalized relative to the thickness of the covering of the grooves, whereby the thickness of the covering can be formed so as to be approximately constantly small over the axial course of the rotor and the magnetization losses through scatter fields are reduced.

Advantageously, the cross section of the grooves constantly diminishes in the transition region away from the bearing in the axial direction. This constant transition makes possible an improvement of the adaptation of a radial outer side of a groove to the peripheral surface of the rotor and the reduction of magnetization losses through scatter fields.

Especially preferably, in each case a radial outer side of each groove lies parallel to the peripheral surface of the rotor. Through the positioning of the radial outer side of the grooves so as to be parallel to the peripheral surface of the rotor, the covering thickness of the grooves can be held constantly small over the entire axial course of the rotor, whereby a minimizing of the magnetization losses and a maximizing of the efficiency are achieved through an enhanced jumping over of the magnetic field onto the stator, this enhancement being uniform over the axial length of the rotor.

Preferably, the transition region of each individual groove displays at least two segments, inside of which the individual grooves display constant cross-sectional areas, the segments of an individual groove displaying cross-sectional areas differing from each other.

Through the arrangement of correspondingly suitable cross-sectional areas in the individual segments, an adaptation to the peripheral surface of the conically tapering rotor is achieved. Hereby, the thickness of the covering over the axial course of the rotor is reduced in total. At the same time, magnetization losses through scatter fields are diminished.

Here, it is of advantage that the grooves be arranged parallel to the rotor axis and radially with respect to the surfaces of the segments bounding the rotor axis. Hereby, the construction of the magnetically conductive material of the rotor can occur in a largely conventional manner.

It is especially preferable here, that the thickness of the greatest covering of a segment be no greater than that of the greatest covering of the segment that is longest in the axial direction, and that the thickness of the least covering of a segment be no less than that of the least covering of the segment that is longest in the axial direction. In this way, the graduated adaptation of the radial outer sides of the grooves to the peripheral surface of the rotor inside of the segments becomes standardized and an improvement of the adaptation as well as a reduction of the magnetization losses through scatter fields are achieved.

Preferably, the covering displays a predetermined thickness between a radially outer groove end and the peripheral surface, whereby the magnetically conductive material of the covering assumes a predetermined saturation degree in the case of all magnetic field strengths prevailing in operation. This predetermined saturation degree promotes an enhanced coupling of the magnetic field from the rotor onto the stator and thus contributes to the increase in the efficiency.

It is especially preferable that the cross-sectional areas of the grooves be designed so as to come to a point towards the radial outer side. The forming of the groove points determines the location at which the jumping of the magnetic field over the air gap and onto the stator occurs. At the same time, unnecessary scatter losses of the magnetic field are prevented. In addition, a better fixing of the electrical conductor in the grooves is made possible. Moreover, by this means the resistances, which vary at different frequencies in consequence of the different depths of penetration of the magnetic field into the conductor, are adapted to the requirements upon startup or during later operation.

Especially advantageous is the application of such a motor in a hermetically encapsulated refrigerant compressor.

In the following, the invention is described in greater detail with reference to a preferred example of embodiment in conjunction with the drawings. These show:

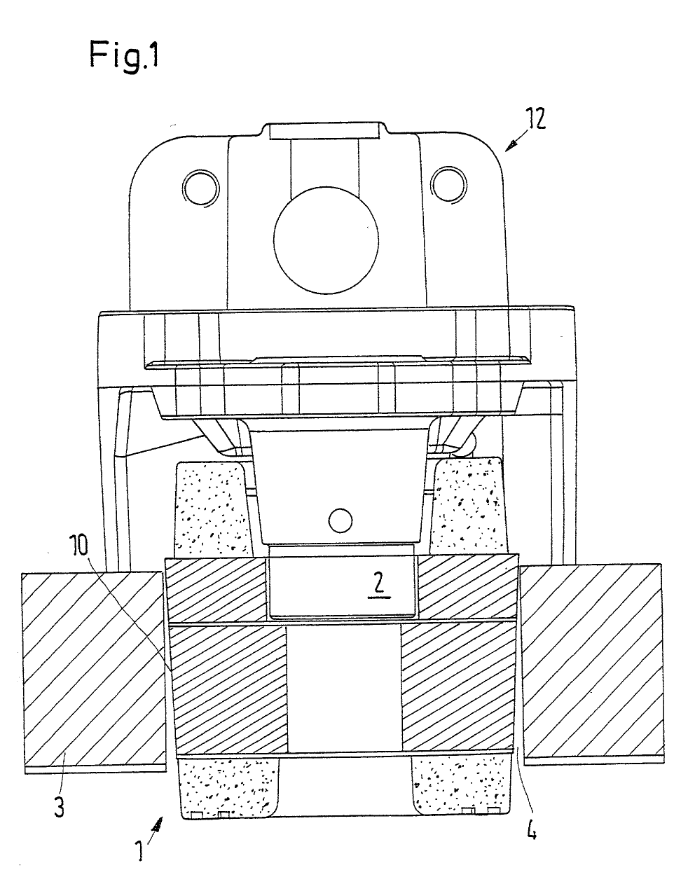

FIG. 1: a section through an electric motor equipped according to the invention;

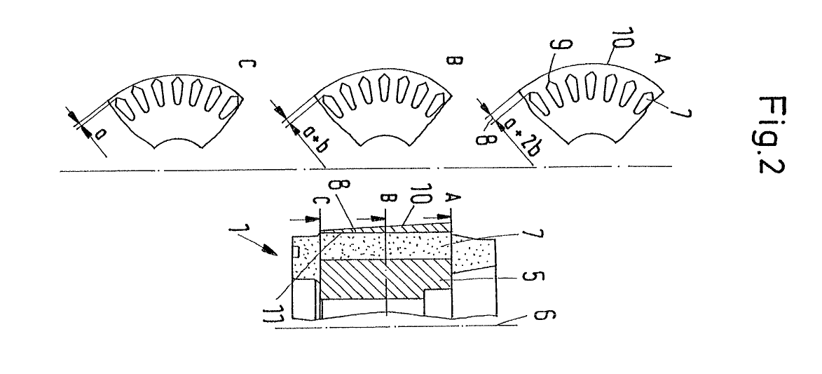

FIG. 2: a section through the rotor with grooves that, corresponding to a known design, display an invariable cross section over the entire length, and three slices of the rotor that show the groove figuration;

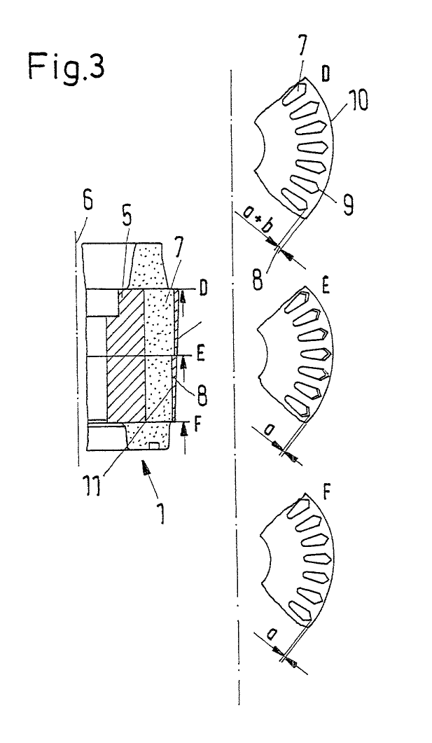

FIG. 3: a section through the rotor with grooves, which display different segments over their lengths, and three slices of the rotor that show the respective groove figurations.

The motor illustrated in FIG. 1 displays a rotor 1, a stator 3, and a cylinder block 12. The rotor 1 is mounted in the stator 3 by means of a bearing 2, and tapers away conically from the bearing 2 in an axial direction. Rotor 1 and stator 3 form an air gap 4, the width of which increases away from the bearing in an axial direction. The air gap 4 is designed such that during the intended operation of the motor a contact between the rotor 1 and the stator 3, caused by occurring vibrations, is excluded.

FIG. 2 shows an embodiment of the rotor 1 according to the prior art, in which the grooves, as known from DE 692 06 626 T2, in each case display a radial outer side 11 that is, over its entire length, constantly distant from a rotor axis 6. The rotor 1 is produced from a magnetically conductive material 5 and displays a number of grooves 7, in which electrical conductors are arranged. In a radial direction between a radially outer groove end 9 and a peripheral surface 10 of the rotor 1, the magnetically conductive material 5 of the rotor 1 forms a covering 8. In addition, FIG. 2 shows detail views of three slices at the sectional planes A, B, C, which together with other (non-represented) slices form the magnetically conductive material 5 of the rotor 1.

FIG. 3 shows the embodiment, according to the invention, of a rotor 1 with grooves 7 that display, in the axial direction, at least two segments (D-E; E-F), inside of which the individual grooves 7 have uniform cross sections, and which segments have cross sections that differ from each other within a groove 7. FIG. 3 further shows detail views of three slices at the sectional planes D, E, F, which together with other (non-represented) slices form the magnetically conductive material 5 of the rotor 1. Within a segment, in the axial direction all of the slices display the same design with respect to the arrangement of the groove, distance of the groove from the rotor axis 6, and size of the groove 7, and differ merely with respect to the outer diameter, which constantly decreases in the axial direction away from the bearing. Relative to each other, the two segments D-E and E-F display differently-sized grooves 7, with the grooves of the segment D-E facing the bearing 2 being larger than the segment E-F opposite the bearing 2. The thickness of the covering 8 decreases in both segments (D-E; E-F) in the axial direction away from the bearing 2, from a value a+b to a value a. Here, b represents the portion of the covering that, as a consequence of the wedge-shaped design of the covering 8 in the axial section of a segment of the covering, constantly decreases in the axial direction away from the bearing 2 from slice to slice, down to a value of zero, and a is the minimum value of the thickness of the covering 8 of the grooves 7. Through an increase of the number of segments that approaches infinity, a gradual transformation of the cross section of the grooves 7 from one end to the other is produced. In this, the radial outer side 11 of each groove lies approximately parallel to the conically-formed surface 10 of the rotor 1.

1. Motor comprising a rotor (1) rotor that is mounted on one side in a stator by means of a bearing (2), tapers away conically from the bearing (2) in an axial direction, and together with the stator (3) forms an air gap (4), the width of which increases in the axial direction away from the bearing, characterized in that the rotor displays a number of axially-extending grooves (7) in an magnetically conductive material (5), in which grooves are arranged electrical conductors, the difference between the maximum value and the minimum value of the thickness of a covering (8) of the grooves (7) by the magnetically conductive material (5) in a radial direction between a radially-outer groove end (9) and a peripheral surface (10) of the rotor (1) being less than in the case of a thickness of the covering (8) that constantly decreases in an axial direction away from the bearing (2).

2. Motor according to claim 1, characterized in that the grooves (7) display, at their end facing the bearing (2), display a different cross-sectional area than at their end opposite the bearing (2), and that arranged between the two ends of each individual groove (7) is a transition region.

3. Motor according to claim 2, characterized in that, in the transition region, the cross section of the grooves (7) constantly diminishes in an axial direction away from the bearing (2).

4. Motor according to one of the claims 1 through 3, characterized in that a radial outer side (11) of each groove (7) in each case lies parallel to the peripheral surface (10) of the rotor (1).

5. Motor according to claim 2, characterized in that the transition region of each individual groove (7) displays at least two segments, within which the individual grooves (7) have constant cross-sectional areas, the segments of an individual groove (7) having cross-sectional areas that differ from each other.

6. Motor according to claim 5, characterized in that the surfaces of the segments that bound the grooves radially towards the rotor axis (6) are arranged parallel to the rotor axis (6).

7. Motor according to one of the claims 5 and 6, characterized in that the thickness of the greatest covering (8) of a segment is no greater than that of the greatest covering (8) of the segment that is longest in the axial direction, and the thickness of the least covering (8) of a segment is no less than that of the least covering (8) of the segment that is longest in the axial direction.

8. Motor according to one of the claims 1 through 7, characterized in that the covering (8) between a radially-outer groove end (9) and the peripheral surface (10) has a predetermined thickness at which the magnetically conductive material (5) of the covering (8) assumes a predetermined degree of saturation in the case of all magnetic field strengths prevailing during operation.

9. Motor according to one of the claims 1 through 9 in that the cross-sectional area of the grooves (7) comes to a point towards the radial outer side (11).

10. Application of the motor according to one of the claims 1 through 9 in a hermetically-encapsulated refrigerant compressor.
